(19) United States
(12) Patent Application Publication
(10) Pub. No.: US 2025/0285396 A1
(43) Pub. Date: Sep. 11, 2025

(54) METHOD FOR PROVIDING VIRTUAL REALITY SPACE BASED ON DIGITAL TWIN, AND COMPUTER PROGRAM RECORDED ON RECORDING MEDIUM FOR EXECUTING METHOD THEREFOR

(71) Applicant: MOBILTECH, Seoul (KR)

(72) Inventors: Jae Seung KIM, Seoul (KR); Kihwan CHA, Gwangmyeong-si (KR)

(21) Appl. No.: 18/746,436

(22) Filed: Jun. 18, 2024

(30) Foreign Application Priority Data
Mar. 8, 2024 (KR) 10-2024-0033222

(51) Int. Cl. G06T 19/20

(52) U.S. Cl. CPC G06T 19/20; G06T 2219/2004

(57) ABSTRACT

Proposed is a method for providing a virtual reality space based on a digital twin, which can provide a realistic experience similar to reality to a user within the virtual reality space. The method may include receiving a 2D design drawing for at least one building, by a service providing device, creating a 3D building model based on the received 2D design drawing, by the service providing device, and creating a virtual reality space by processing the created 3D building model, by the service providing device.

### CROSS REFERENCE TO RELATED APPLICATION

This application claims priority from Republic of Korea Patent Application No. 10-2024-0033222, filed on Mar. 8, 2024, which is hereby incorporated by reference in its entirety.

### BACKGROUND

### Field

The present disclosure relates to a digital twin. More particularly, the present disclosure relates to a method for providing a virtual reality space based on a digital twin and a computer program recorded on a recording medium to execute the method, which can implement a 3D virtual reality space for a building and provide a realistic experience similar to reality to a user within the virtual reality space implemented based on the digital twin.

### Related Art

A digital twin refers to a real-world object (object, space, environment, process, procedure, etc.) expressed as a digital data model on a computer, replicating the object exactly and enabling real-time interactions. Unlike the metaverse which focuses on the operation of an independent virtual world, the digital twin emphasizes combining technologies such as the Internet of Things (IoT), sensors, and high-speed communication to reflect a real-world state in a virtual model in real time and operate like a twin.

Meanwhile, a model house is a sales promotion center operated by a construction company or consignment developer to promote and sell newly built or under-construction apartments, studio apartments, and knowledge industry centers. The model house is a house built to closely resemble an actual building to be built as a model to sell the house to a consumer. However, the model house has many differences from actual construction, so there is a problem in providing accurate information to consumers. In addition, the model house is problematic in that once its role in promoting the building is over, the model house is immediately demolished or abandoned to become a derelict building unless other facilities move in.

In order to solve these problems, recently, a conventional system of viewing and purchasing a house through an offline model house has evolved. A virtual model house is being developed that allows consumers to safely experience more information through online virtual reality and make more rational decisions.

However, the virtual model house which is being developed has a problem in obtaining all information about an actual building due to a limited movement range and a fixed view of point within the virtual reality space.

### PRIOR ART DOCUMENT

### (Patent Document)

(Patent Document 1) Korean Patent Publication No. 10-2020-0021685, ‘System, server and method for providing model house service’, (2020 Mar. 2.)

### SUMMARY

The present disclosure provides a method for providing a virtual reality space based on a digital twin, which can provide a realistic experience similar to reality to a user within the virtual reality space implemented based on the digital twin.

The present disclosure also provides a computer program recorded on a recording medium to execute a method for providing a virtual reality space based on a digital twin, which can provide a realistic experience similar to reality to a user within the virtual reality space implemented based on the digital twin.

The problems to be solved by the present disclosure are not limited to the above-mentioned problems, and other problems which are not mentioned will be clearly understood by those skilled in the art from the following description.

In an aspect, the present disclosure provides a method for providing a virtual reality space based on a digital twin, which can provide a realistic experience similar to reality to a user within the virtual reality space. The method may include receiving a 2D design drawing for at least one building, by a service providing device, creating a 3D building model based on the received 2D design drawing, by the service providing device, and creating a virtual reality space by processing the created 3D building model, by the service providing device.

The receiving may receive the 2D design drawing including at least one of a plan view, a sectional view, an elevation view, and a layout drawing for an architecture book or an interior design book of the at least one building.

The creating of the building model may identify the type and scale of components forming the at least one building based on the 2D design drawing, and place a 3D element model, which is previously stored according to the type of the identified component, according to an identified scale, thereby generating a 3D building model.

The creating of the building model may identify a type of the component based on at least one of the type, thickness, and shape of lines constituting the 2D design drawing, and identify the scale of the component based on numbers written in the 2D design drawing.

The creating of the virtual reality space may create a virtual solar model in the created virtual reality space, estimate solar azimuth and solar altitude by time based on a latitude and longitude corresponding to an actual location of the 3D building model, and generate real-time sunshine and shadows in the virtual reality space according to the estimated solar azimuth and solar altitude.

The creating of the virtual reality space may receive point cloud data acquired by a lidar at a preset location in real space corresponding to the virtual reality space, and create an outdoor environment model for the created 3D building model based on the received point cloud data.

The creating of the virtual reality space may generate the outdoor environment model of the same scale as the 3D building model by converting the depth information of the received point cloud data to the scale of the 3D building model.

After the creating of the virtual reality space, the method may further comprise providing a service to user equipment by placing an avatar corresponding to a user within the virtual reality space.

The providing may control the action of the avatar in the virtual reality space according to an input signal that is input from the user equipment, and implement contents corresponding to the action of the avatar in the virtual reality space.

The providing may provide a front view based on eyes of the avatar within the virtual reality space, receive the avatar's height information from the user equipment, and adjust a viewpoint based on the received height information.

When the avatar is placed inside the 3D building model and one of the components of the 3D building model is selected from the user equipment, the providing may identify components having the same properties as the component selected from the 3D building model, provide a changeable component list to the user equipment to change the design of the identified components, and change the identified components to the changeable component selected from the user equipment.

When the avatar is placed inside the 3D building model and one of the components of the 3D building model is selected from the user equipment, the providing may provide a user interface (UI) to change a location or design of the selected component and change the location or design of the selected component according to an input from the user equipment through the user interface.

The computer program may be coupled to a computing device including a memory, a transceiver, and a processor processing a command loaded in the memory. The computer program may be recorded on the recording medium to execute receiving a 2D design drawing for at least one building by a processor, creating a 3D building model based on the received 2D design drawing by the processor, and creating a virtual reality space by processing the created 3D building model by the processor.

Specific details of other embodiments are included in the detailed description and drawings.

According to embodiments of the present disclosure, by automatically creating a virtual reality space including a 3D building model based on a 2D design drawing for the design of an actual building, the virtual reality space similar to reality can be created through a minimal process.

Further, according to embodiments of the present disclosure, by implementing contents corresponding to the action of an avatar on an implemented 3D virtual reality space, it is possible to provide a user with a realistic experience similar to reality through interaction with the user in the virtual reality space.

Effects of the present disclosure are not limited to the above-mentioned effects, and other effects which are not mentioned will be clearly understood by those skilled in the art from the following claims.

### BRIEF DESCRIPTION OF THE DRAWINGS

FIG. 1 is a configuration diagram of a system for providing a virtual reality space according to an embodiment of the present disclosure.

FIG. 2 is a logical configuration diagram of a service providing device according to an embodiment of the present disclosure.

FIGS. 3 to 5 are diagrams illustrating the process of creating a virtual reality space according to an embodiment of the present disclosure.

FIGS. 6 to 10 are diagrams illustrating a service providing process according to an embodiment of the present disclosure.

FIG. 11 is a hardware configuration diagram of the service providing device according to an embodiment of the present disclosure.

FIG. 12 is a flowchart illustrating a method for providing a virtual reality space service according to an embodiment of the present disclosure.

### DESCRIPTION OF EXEMPLARY EMBODIMENTS

It should be noted that technical terms used in this specification are only used to describe specific embodiments and are not intended to limit the present disclosure. Unless otherwise defined, the technical terms used herein should be interpreted as meanings generally understood by those skilled in the art in the technical field to which the present disclosure pertains, and should not be interpreted in an overly comprehensive or overly narrow sense. Further, if the technical terms used in this specification are incorrect technical terms that do not accurately express the idea of the present disclosure, they should be replaced with technical terms that can be correctly understood by those skilled in the art. Furthermore, general terms used in the present disclosure should be interpreted according to the definition in the dictionary or the context, and should not be interpreted in an excessively limited sense.

In the present disclosure, the singular forms are intended to include the plural forms as well, unless the context clearly indicates otherwise. It will be further understood that the terms “comprise”, “have”, etc. when used in this specification, specify the presence of stated steps or components but do not preclude the presence or addition of one or more other steps or components.

It will be understood that, although the terms “first”, “second”, etc. may be used herein to describe various elements, these elements should not be limited by these terms. These terms are only used to distinguish one element from another element. For instance, a first element could be termed a second element without departing from the scope of the present disclosure. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present.

Hereinafter, preferred embodiments of the present disclosure will be described in detail with reference to the accompanying drawings. Like reference numerals refer to like parts throughout various figures and embodiments of the present disclosure, and a duplicated description thereof will be omitted. When it is determined that the detailed description of the known art related to the present disclosure may obscure the gist of the present disclosure, the detailed description will be omitted. Further, it is to be noted that the accompanying drawings are only intended to easily understand the spirit of the present disclosure and are not to be construed as limiting the spirit of the present disclosure. It is to be understood that the present disclosure is intended to cover not only the exemplary embodiments, but also various alternatives, modifications, equivalents and other embodiments that fall within the spirit and scope of the present disclosure.

Recently, a conventional system of viewing and purchasing a house through an offline model house has evolved. A virtual model house is being developed that allows consumers to safely experience more information through online virtual reality and make more rational decisions.

However, the virtual model house which is being developed has a problem in obtaining all information about an actual building due to a limited movement range and a fixed view of point within the virtual reality space.

In order to overcome these limitations, the present disclosure seeks to propose various means that can provide a realistic experience of a product through interaction with a user in a 3D virtual reality space.

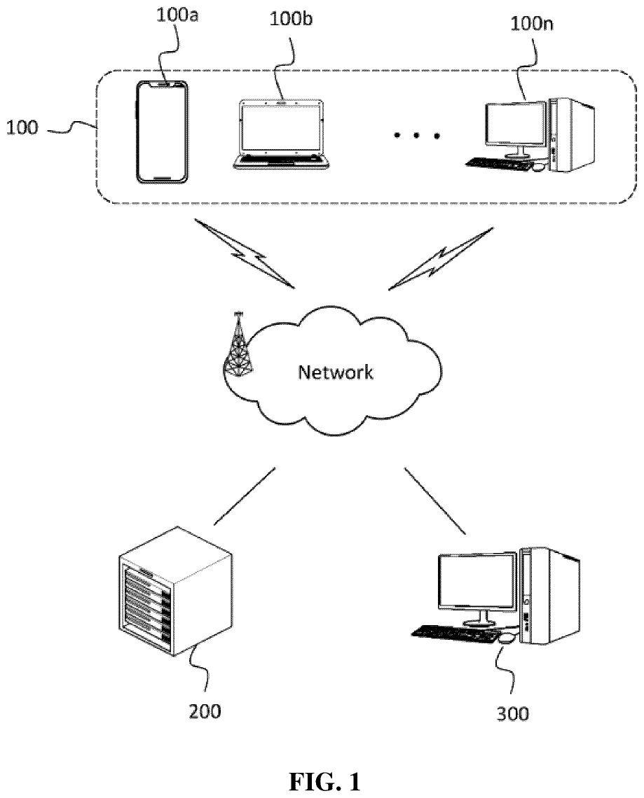

FIG. 1 is a configuration diagram of a system for providing a virtual reality space according to an embodiment of the present disclosure.

Referring to FIG. 1, the virtual reality space providing system 400 according to an embodiment of the present disclosure may include user equipment 100, 100a, 100b, . . . , 100n, a drawing management device 200, and a service providing device 300.

Since the virtual reality space providing system 400 according to an embodiment of the present disclosure merely represents functionally distinct components, two or more components may be integrated with each other in an actual physical environment, or one component may be separated in the actual physical environment.

When describing each component, the user equipment 100 may be a device carried by a user to receive a realistic experience in the virtual reality space implemented by the service providing device 300.

Specifically, the user equipment 100 may access a web site provided by the service providing device 300. Then, the user equipment 100 may place an avatar corresponding to the user in the virtual reality space implemented on the web site provided by the service providing device 300. However, without being limited thereto, the user equipment 100 may place the avatar corresponding to the user in the virtual reality space through an application provided by the service providing device 300.

Further, the user equipment 100 may control the action of the avatar in the virtual reality space by receiving an input signal from the user to move the avatar placed in the virtual reality space. Here, the action of the avatar may include the movement of the avatar in the virtual reality space, the change of architectural components, and the change of viewpoint within a building.

The user equipment 100, which has the above-described characteristics, is not limited to the User Equipment (UE) specified in the 3GPP (3rd Generation Partnership Project), and any device is possible as long as it may transmit and receive data to and from a management server 200 and perform operations based on the transmitted and received data. For example, the user equipment 100 may be any one of a stationary computing device such as a desktop, a workstation, or a server, or a mobile computing device such as a smart phone, a laptop, a tablet, a phablet, a Portable Multimedia Player (PMP), a Personal Digital Assistant (PDA) or an E-book reader.

In the following configuration, the drawing management device 200 may generate and store a 2D design drawing for at least one building for implementing the virtual reality space, and provide the stored 2D design drawing to the service providing device 300 at the request of the service providing device 300. Here, the 2D design drawing may include at least one of a plan view, a sectional view, an elevation view, and a layout drawing for an architecture book or an interior design book of at least one building.

Such a drawing management device 200 may be a device possessed by a manager of a construction company in charge of construction, such as design and civil engineering, for at least one building in a real environment.

The drawing management device 200, which has the above-described characteristics, may be any device as long as it may transmit and receive data to and from the service providing device 300 and perform operations based on the transmitted and received data. For example, the drawing management device 200 may be any one of a stationary computing device such as a desktop, a workstation, or a server, but is not limited thereto.

In the following configuration, the service providing device 300 may provide a realistic experience similar to the reality to the user through the user equipment 100 within the virtual reality space implemented based on the digital twin.

Specifically, the service providing device 300 may receive the 2D design drawing for at least one building, generate a 3D building model based on the received 2D design drawing, and process the generated 3D building model to create the virtual reality space.

Further, the service providing device 300 may place the avatar corresponding to the user in the implemented virtual reality space and then provide the avatar to the user equipment. That is, the service providing device 300 may control the action of the avatar in the virtual reality space according to the input signal that is input from the user equipment 100, and implement contents corresponding to the action of the avatar in the virtual reality space.

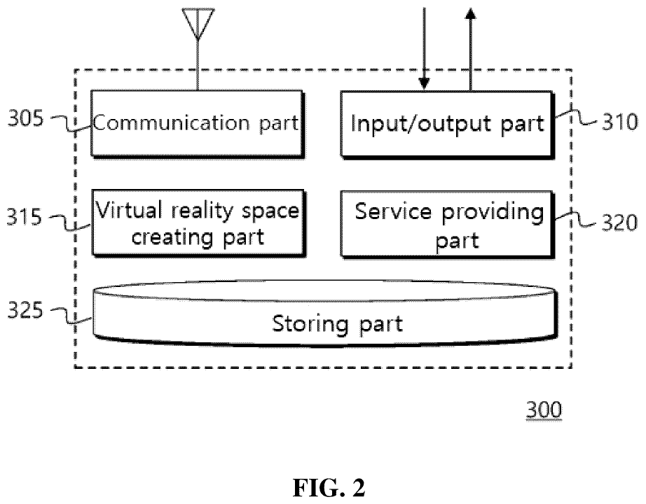

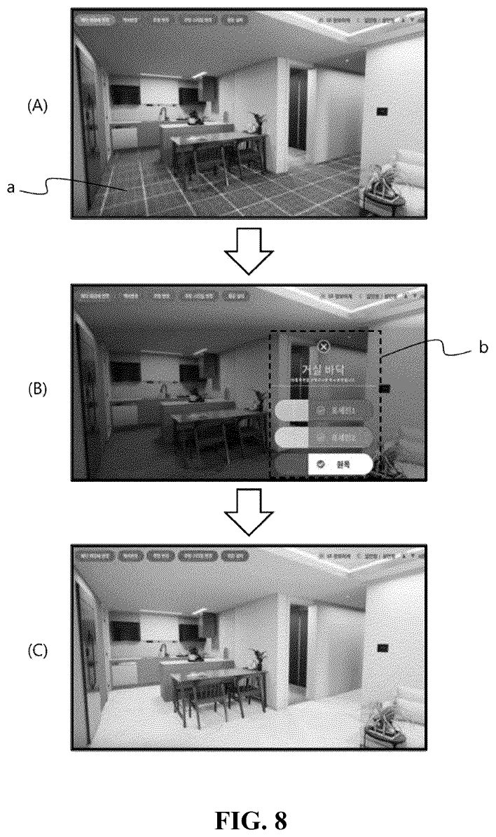

Meanwhile, a detailed description of the service providing device 300 will be described later with reference to FIGS. 2 to 11.

As described above, the user equipment 100, the drawing management device 200, and the service providing device 300 may transmit and receive data using a network that combines one or more of a security line, a public wired communication network, or a mobile communication network directly connected between devices.

For example, the public wired communication network may include Ethernet, x Digital Subscriber Line (xDSL), Hybrid Fiber Coax (HFC), and Fiber To The Home (FTTH), but is not limited thereto. Further, the mobile communication network may include Code Division Multiple Access (CDMA), Wideband CDMA (WCDMA), High Speed Packet Access (HSPA), Long Term Evolution (LTE), and 5th generation mobile telecommunication, but is not limited thereto.

Hereinafter, the logic configuration of the service providing device according to an embodiment of the present disclosure will be described in detail.

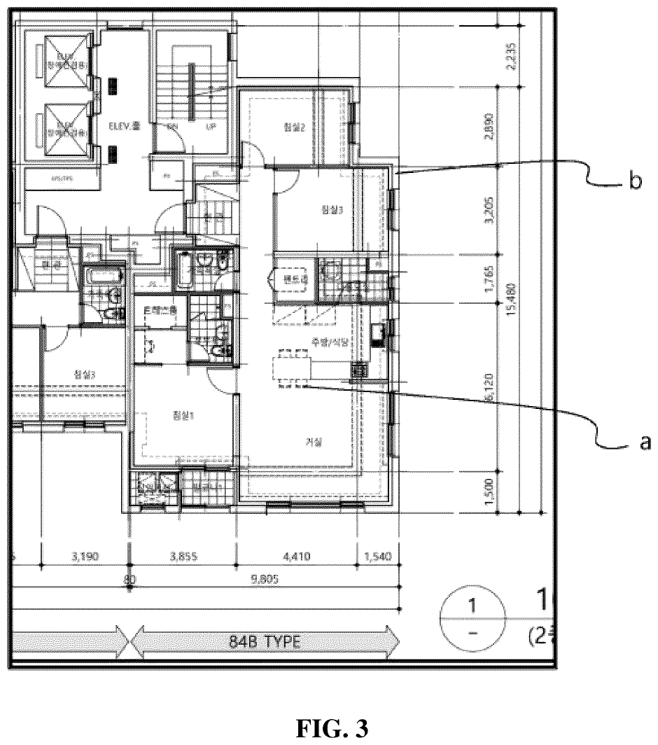

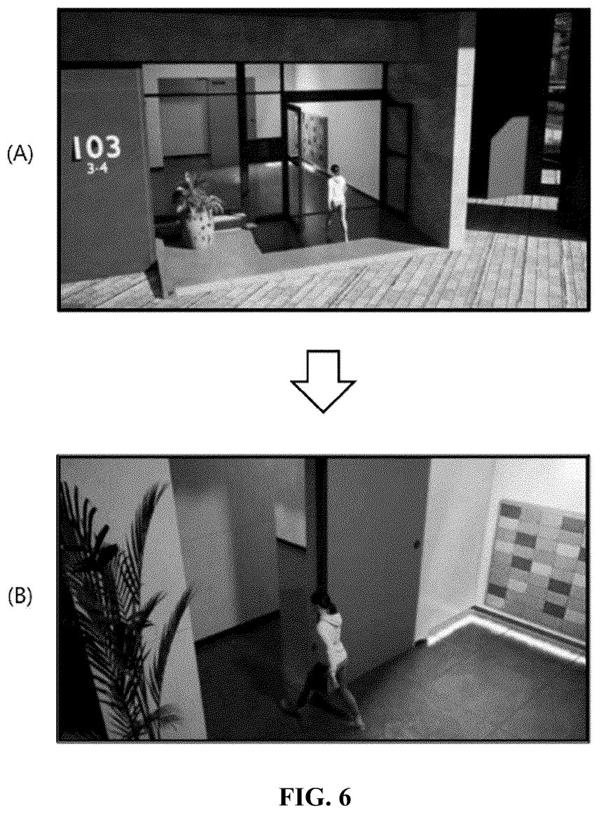

FIG. 2 is a logical configuration diagram of a service providing device according to an embodiment of the present disclosure, FIGS. 3 to 5 are diagrams illustrating the process of creating a virtual reality space according to an embodiment of the present disclosure, and FIGS. 6 to 10 are diagrams illustrating a service providing process according to an embodiment of the present disclosure.

As shown in FIG. 2, the service providing device 300 according to an embodiment of the present disclosure may include a communication part 305, an input/output part 310, a virtual reality space creating part 315, a service providing part 320, and a storing part 325.

Since the components of the service providing device 300 merely represent functionally distinct components, two or more components may be integrated with each other in an actual physical environment, or one component may be separated in the actual physical environment.

When describing each component, the communication part 305 may transmit and receive data to and from the user equipment 100 and the drawing management device 200.

Specifically, the communication part 305 may control the action of the avatar in the virtual reality space from the user equipment, and receive the input signal for implementing the contents corresponding to the action of the avatar in the virtual reality space. Further, the communication part 305 may place the avatar corresponding to the user within the virtual reality space, and transmit data for providing the service to the user equipment to the user equipment 100. Further, the communication part 305 may receive the 2D design drawing from the drawing management device.

In the following configuration, the input/output part 310 may receive setting information for implementing the 3D virtual reality space. Further, the input/output part 310 may output the implemented 3D virtual reality space, and support to output and monitor the action of the avatar, which is performed by the user equipment or the service providing device.

In the following configuration, the virtual reality space creating part 315 may implement the 3D virtual reality space based on the 2D design drawing that is provided from the drawing management device.

To this end, the virtual reality space creating part 315 may receive the 2D design drawing for at least one building from the drawing management device. Specifically, the virtual reality space creating part 315 may receive the 2D design drawing including at least one of the plan view, the sectional view, the elevation view, and the layout drawing for the architecture book or the interior design book of at least one building from the drawing management device.

When the 2D design drawing is received, the virtual reality space creating part 315 may create the 3D building model based on the received 2D design drawing. At this time, the virtual reality space creating part 315 may identify the type and scale of components forming at least one building based on the 2D design drawing. Here, the components forming the building may include components that make up the exterior of the building, such as walls, windows, doors, and stairs, and interior design components such as built-in closets, dining tables, sinks, sofas, and dressing tables.

Here, the virtual reality space creating part 315 may identify the type of the component based on at least one of the type, thickness, and shape of lines constituting the 2D design drawing, and identify the scale of the component based on numbers written in the 2D design drawing. For example, as shown in FIG. 3, the virtual reality space creating part 315 may identify the dotted line (a) as furniture related to the interior design, and identify the solid line (b) as a wall, window, etc. In addition, the virtual reality space creating part 315 may identify detailed components through the shape of the line as well as the thickness of the line. Further, the virtual reality space creating part 315 may identify a room, living room, kitchen, etc. by perceiving text existing in the 2D design drawing. Through this, the virtual reality space creating part 315 may identify whether each component is a wall in a living room or a window in a bedroom.

Further, the virtual reality space creating part 315 may place a 3D element model, which is previously stored according to the type of the identified component, according to an identified scale, thereby generating a 3D building model. For example, the virtual reality space creating part 315 may place the 3D element model stored by type, such as a living room floor, a kitchen floor, a floor of room 1, a floor of room 2, a living room wall, a wall of room 1, a wall of room 2, a window of room 1, or a window of room 2, according to the identified scale. Here, the 3D element model may store information about properties such as the type, material, and color of each component.

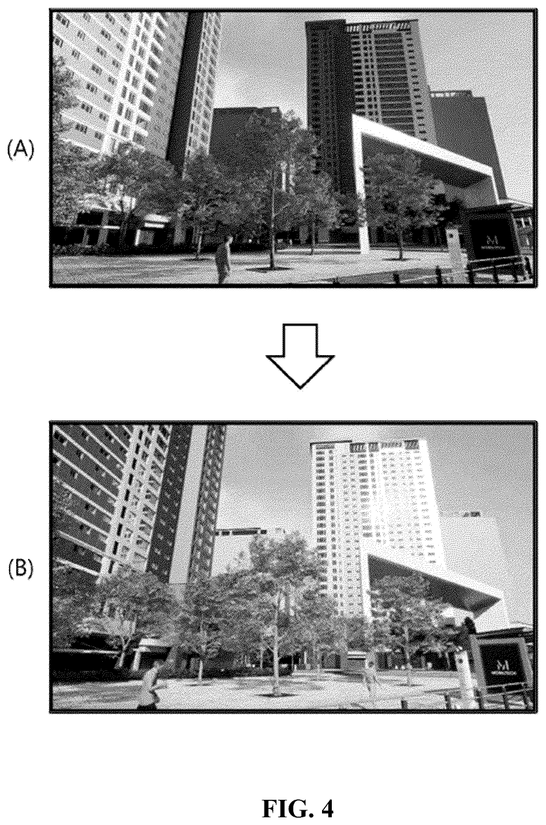

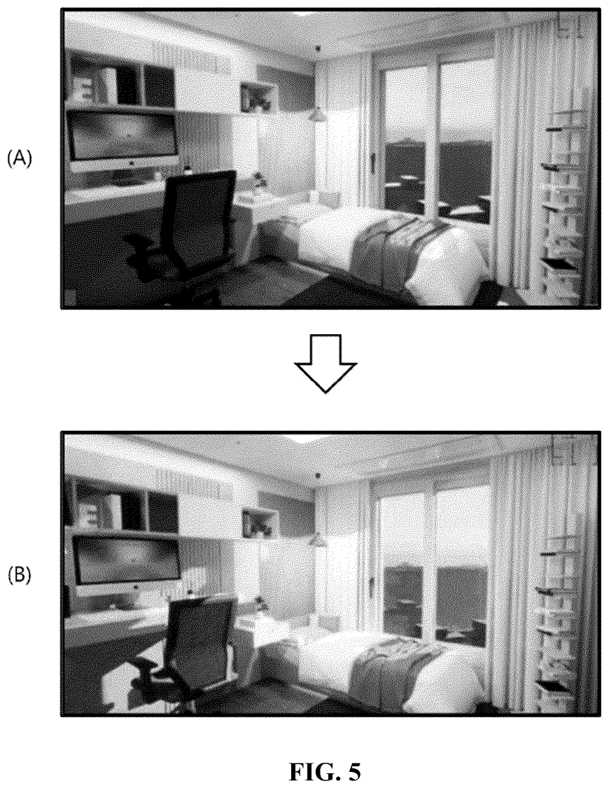

The virtual reality space creating part 315 may create a virtual solar model in the created virtual reality space, estimate solar azimuth and solar altitude by time based on the latitude and longitude corresponding to the actual location of the 3D building model, and generate real-time sunshine and shadows in the virtual reality space according to the estimated solar azimuth and solar altitude. Meanwhile, (A) in FIG. 4 is a diagram showing sunshine and shadows in the virtual reality space, and (B) is a diagram showing sunshine and shadows changed according to different perspectives at the same point as the location of (A). As shown in FIG. 4, the virtual reality space creating part 315 may generate sunshine or shadows on buildings, floors, trees, etc. depending on the angle of the sun. Meanwhile, (A) in FIG. 5 is a drawing showing sunshine and shadows inside the 3D architectural model, and (B) is a drawing showing sunshine and shadows changed according to different perspectives at the same point as the location of (A). As shown in FIG. 5, the virtual reality space creating part 315 may generate real-time sunshine and shadows even inside the 3D architectural model. Thereby, the virtual reality space creating part 315 may support a user to check the amount of sunshine in a building in advance.

Further, the virtual reality space creating part 315 may receive point cloud data acquired by a lidar at a preset location in real space corresponding to virtual reality space, and create an outdoor environment model for the generated 3D building model based on the received point cloud data. That is, as described above, the virtual reality space creating part 315 may create the 3D architectural model based on the 2D design drawing, but may not create outdoor environment of the 3D architectural model such as trees, other buildings, floors, etc. Thus, the virtual reality space creating part 315 may create the outdoor environment model for the 3D building model through the point cloud data acquired by the lidar at a preset location in the real space corresponding to the virtual reality space. Specifically, the virtual reality space creating part 315 may create a depth map using the depth information of the received point cloud data, and create the outdoor environment model by configuring a plurality of voxels based on the depth information included in the generated depth map. For example, the virtual reality space creating part 315 may divide the space by connecting all the points included in the depth map with triangles, and divide the space so that the minimum value of the interior angles of the triangles is the maximum. However, without being limited thereto, the virtual reality space creating part 315 may create the outdoor environment model through various methods such as Voronoi diagram. At this time, the virtual reality space creating part 315 may generate the outdoor environment model of the same scale as the 3D building model by converting the depth information included in the depth map to the scale of the 3D building model.

In the following configuration, the service providing part 320 may place the avatar corresponding to the user within the virtual reality space to provide the service to the user equipment.

Specifically, the service providing part 320 may control the action of the avatar in the virtual reality space according to the input signal that is input from the user equipment 100, and implement contents corresponding to the action of the avatar in the virtual reality space.

According to an embodiment, as shown in FIG. 6, when the input signal about a specific point or a specific direction in the virtual reality space is input from the user equipment, the service providing part 320 may move the avatar to the specific point or the specific direction within the virtual reality space according to the input signal. Thereby, the service providing part 320 allows the avatar to freely move around the exterior of the 3D architectural model in the virtual reality space as shown in (A), and allows the avatar to freely move around the interior of the 3D architectural model as shown in (B), thereby supporting to check the movement lines, structure, and interior design from the exterior to the interior of the 3D architectural model.

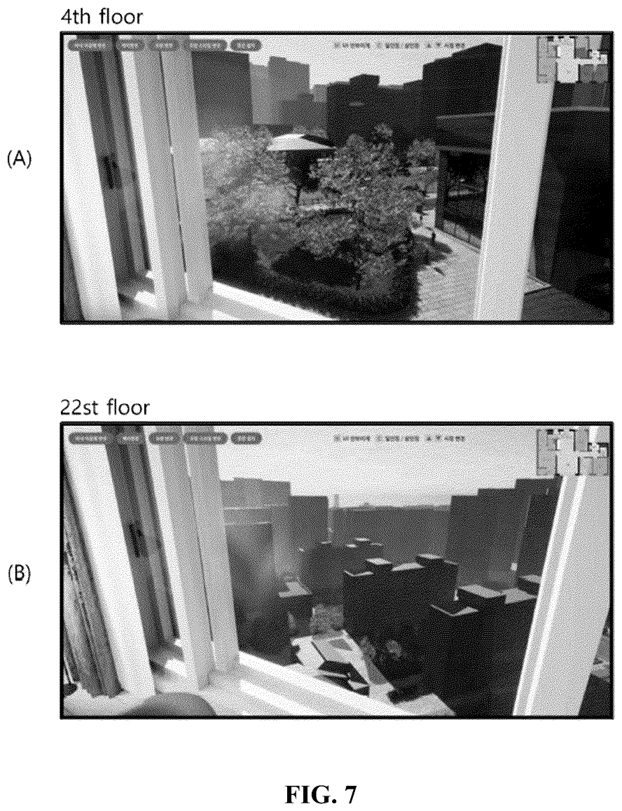

According to another embodiment, as shown in FIG. 7, the service providing part 320 may provide a front view based on the eyes of the avatar within the virtual reality space. For example, the service providing part 320 allows the avatar to view the outdoor environment with the avatar positioned on the 4th floor of the 3D architectural model according to the input signal of the user equipment as shown in (A), and allows the avatar to view the outdoor environment with the avatar positioned on the 22th floor of the 3D architectural model according to the input signal of the user equipment as shown in (B). Thereby, the service providing part 320 supports the user to check the realistic view outside the window of each floor in the virtual space. At this time, the service providing part 320 may receive the avatar's height information from the user equipment, and adjust a viewpoint based on the received height information. For example, the service providing part 320 provides a user interface (UI) that may change the avatar's viewpoint on the user equipment, allowing the avatar's height information to be input from the user equipment.

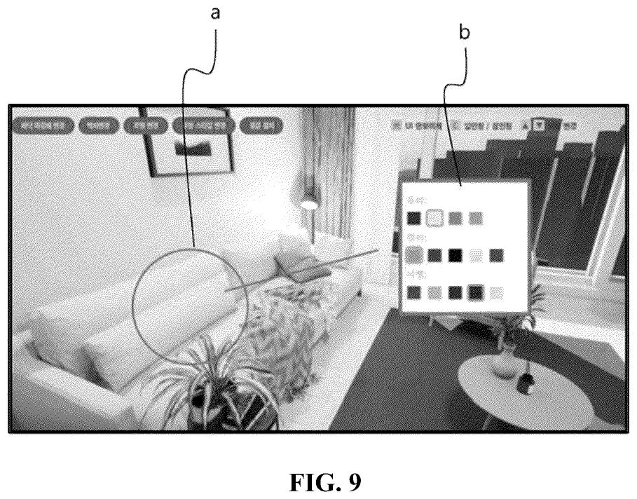

According to another embodiment, when the avatar is placed inside the 3D building model and one of the components of the 3D building model is selected from the user equipment, the service providing part 320 may identify components having the same properties as the component selected from the 3D building model, provide a changeable component list to the user equipment to change the design of the identified components, and change the identified components to the changeable component selected from the user equipment. For example, as shown in (A) of FIG. 9, when a specific point in the living room floor is selected from the user equipment, the service providing part 320 may identify the entire living room floor based on property information, and indicate a change area (a) corresponding to the identified living room floor. Subsequently, as shown in (B), the service providing part 320 may provide a changeable component list to change the design of the living room floor. That is, the service providing part 320 may provide a list of designs for the living room floor, such as porcelain, solid wood, and engineered hardwood floors, and provide a user interface that may select a desired design from the provided design list. Further, as shown in (C), the service providing part 320 may change the living room floor to a design selected by the user equipment.

According to another embodiment, when the avatar is placed inside the 3D building model and one of the components of the 3D building model is selected from the user equipment, the service providing part 320 may provide the user interface (UI) to change the location or design of the selected component, and change the location or design of the selected component according to an input from the user equipment through the user interface. For example, as shown in FIG. 9, when a sofa (a) is selected from the user equipment, the service providing part 320 may provide the user interface (b) that may change the material, color, etc. of the selected sofa and change the sofa to the selected design. Further, the service providing part 320 may provide the user interface that may move the selected sofa to another location by dragging it.

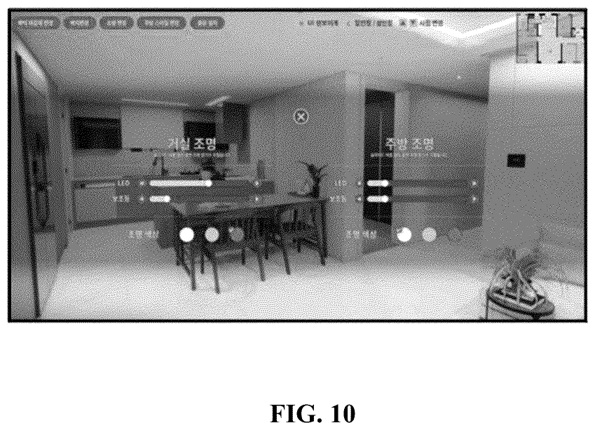

According to a further embodiment, as shown in FIG. 10, when the avatar is placed inside the 3D building model and an input signal for changing lighting is input from the user equipment, the service providing part 320 may provide the user interface that may change a lighting intensity, a lighting color, etc., and change the lighting according to the selected lighting intensity and lighting color.

Hereinafter, hardware for implementing the logical components of the above-mentioned service providing device will be described in detail.

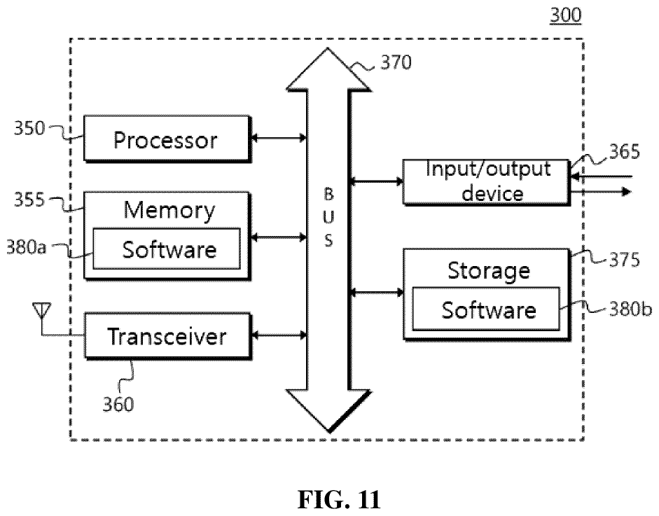

FIG. 11 is a hardware configuration diagram of the service providing device according to an embodiment of the present disclosure.

As shown in FIG. 11, the service providing device 300 may include a processor 350, a memory 355, a transceiver 360, an input/output device 365, a data bus 370, and a storage 375.

Specifically, the processor 350 may implement the operation and function of the service providing device 300 based on a command according to software 380a in which the virtual reality space providing method is implemented and which is loaded in the memory 355.

Software 380b in which the virtual reality space providing method is implemented and which is stored in the storage 375 may be loaded in the memory 355.

The input/output device 365 may receive a signal required for the operation of the service providing device 300 or output calculation results to the outside according to an instruction from the processor 350.

The data bus 370 may be connected to the processor 350, the memory 355, the transceiver 360, the input/output device 365, and the storage 375, and serve as a moving path for transferring a signal between components.

The storage 375 may store an application programming interface (API), a library file, a resource file, etc. required to execute the software 380a in which the virtual reality space providing method according to embodiments of the present disclosure is implemented. The storage 375 may store software 380b in which the virtual reality space providing method according to embodiments of the present disclosure is implemented.

According to an embodiment of the present disclosure, the software 380a and 380b loaded in the memory 355 or stored in the storage 375 to implement the virtual reality space providing method may be a computer program recorded on a recording medium so as to execute a step in which the processor 350 receives the 2D design drawing for at least one building, a step in which the processor 350 generates the 3D building model based on the received 2D design drawing, and a step in which the processor 350 generates the virtual reality space by processing the generated 3D building model.

To be more specific, the processor 350 may include one or more of a Central Processing Unit (CPU), an Application-Specific Integrated Circuit (ASIC), a chipset, and a logic circuit, without being limited thereto.

The memory 355 may include one or more of a Read-Only Memory (ROM), a Random Access Memory (RAM), a flash memory, and a memory card, without being limited thereto.

The input/output device 360 may include one or more of an input device such as a button, a switch, a keyboard, a mouse, or a joystick, and an output device such as a Liquid Crystal Display (LCD), a Light Emitting Diode (LED), an Organic LED (OLED), an Active Matrix OLED (AMOLED), a printer, or a plotter, without being limited thereto.

When an embodiment included herein is implemented as software, the above-described method may be implemented as modules (process, function, etc.) that perform the above-described function. Each module may be loaded in the memory 355 and be executed by the processor 350. The memory 355 may be internal or external to the processor 350, and may be connected to the processor 350 via a variety of well-known means.

Each component shown in FIG. 11 may be implemented by various means, e.g., hardware, firmware, software, or a combination thereof. In the case of implementation by hardware, an embodiment of the present disclosure may be implemented by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, microcontrollers, microprocessors, and the like.

Further, in the case of implementation by firmware or software, an embodiment of the present disclosure may be implemented in the form of a module, procedure, function, etc. that performs the functions or operations described above, and then be recorded on the recording medium readable through various computer means. Here, the recording medium may include program instructions, data files, data structures, etc., alone or in combination.

The program instructions recorded on the recording medium may be instructions that are especially designed and constructed for the present disclosure, or may be known and available to those skilled in the art of computer software. For instance, the recording medium includes magnetic media such as hard disks, floppy disks and magnetic tapes, optical media such as CD-ROM (Compact Disk Read Only Memory) and DVD (Digital Video Disk), magneto-optical media such as floptical disks, and hardware devices specially configured to store and execute program instructions such as ROM, RAM, flash memory, etc.

Examples of program instructions may include machine language code such as that created by a compiler as well as high-level language code that may be executed by a computer using an interpreter, etc. Such a hardware device may be configured to operate as one or more software so as to perform the operation of the present disclosure, and vice versa.

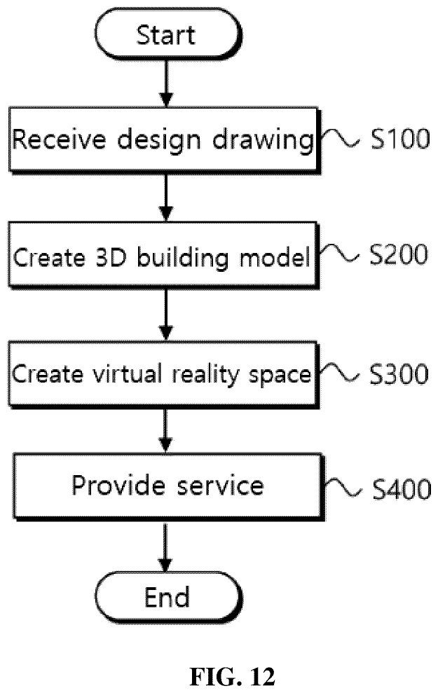

FIG. 12 is a flowchart illustrating a method for providing a virtual reality space service according to an embodiment of the present disclosure.

Referring to FIG. 12, first, in step S100, the service providing device may receive the 2D design drawing for at least one building from the drawing management device. Specifically, the service providing device may receive the 2D design drawing including at least one of the plan view, the sectional view, the elevation view, and the layout drawing for the architecture book or the interior design book of at least one building from the drawing management device.

Next, in step S200, the service providing device may create the 3D building model based on the received 2D design drawing. At this time, the service providing device may identify the type and scale of components forming at least one building based on the 2D design drawing.

Here, the service providing device may identify the type of the component based on at least one of the type, thickness, and shape of lines constituting the 2D design drawing, and identify the scale of the component based on numbers written in the 2D design drawing.

Further, in step S300, the service providing device may place a 3D element model, which is previously stored according to the type of the identified component, according to an identified scale, thereby generating a 3D building model. Here, the 3D element model may store information about properties such as the type, material, and color of each component.

Further, the service providing device may create a virtual solar model in the created virtual reality space, estimate solar azimuth and solar altitude by time based on the latitude and longitude corresponding to the actual location of the 3D building model, and generate real-time sunshine and shadows in the virtual reality space according to the estimated solar azimuth and solar altitude.

Further, the service providing device may receive point cloud data acquired by a lidar at a preset location in real space corresponding to virtual reality space, and create an outdoor environment model for the generated 3D building model based on the received point cloud data. Specifically, the service providing device may create a depth map using the depth information of the received point cloud data, and create the outdoor environment model by configuring a plurality of voxels based on the depth information included in the generated depth map. At this time, the service providing device may generate the outdoor environment model of the same scale as the 3D building model by converting the depth information included in the depth map to the scale of the 3D building model.

The service providing device may place the avatar corresponding to the user within the virtual reality space to provide the service to the user equipment.

Specifically, the service providing device may control the action of the avatar in the virtual reality space according to the input signal that is input from the user equipment, and implement contents corresponding to the action of the avatar in the virtual reality space.

According to an embodiment, when the input signal about a specific point or a specific direction in the virtual reality space is input from the user equipment, the service providing device may move the avatar to the specific point or the specific direction within the virtual reality space according to the input signal.

According to another embodiment, the service providing device may provide a front view based on the eyes of the avatar within the virtual reality space. At this time, the service providing device may receive the avatar's height information from the user equipment, and adjust a viewpoint based on the received height information.

According to another embodiment, when the avatar is placed inside the 3D building model and one of the components of the 3D building model is selected from the user equipment, the service providing device may identify components having the same properties as the component selected from the 3D building model, provide a changeable component list to the user equipment to change the design of the identified components, and change the identified components to the changeable component selected from the user equipment.

According to another embodiment, when the avatar is placed inside the 3D building model and one of the components of the 3D building model is selected from the user equipment, the service providing device may provide the user interface (UI) to change the location or design of the selected component, and change the location or design of the selected component according to an input from the user equipment through the user interface.

According to a further embodiment, when the avatar is placed inside the 3D building model and an input signal for changing lighting is input from the user equipment, the service providing device may provide the user interface that may change a lighting intensity, a lighting color, etc., and change the lighting according to the selected lighting intensity and lighting color.

As described above, preferred embodiments of the present disclosure have been disclosed in the specification and drawings. However, it is self-evident to those skilled in the art that other modifications may be made in addition to the embodiments disclosed herein. Although specific terms are used in the specification and drawings, they are merely for the purpose of describing particular embodiments only and are not intended to be limiting. Accordingly, the above description should not be construed as restrictive in all respects and should be considered illustrative. The scope of the present disclosure is indicated by the scope of the claims described below rather than a detailed description, and all changes or modifications derived from claims and equivalences thereof should be construed as being included in the scope of the present disclosure.

### DESCRIPTION OF REFERENCE NUMERALS

100: user equipment 200: drawing management device
300: service providing device
305: communication part 310: input/output part
315: virtual reality space creating part 320: service providing part
325: storing part

What is claimed is:

1. A method for providing a virtual reality space based on a digital twin comprising:
receiving a 2D design drawing for at least one building, by a service providing device;
creating a 3D building model based on the received 2D design drawing, by the service providing device; and
creating a virtual reality space by processing the created 3D building model, by the service providing device.

2. The method of claim 1, wherein the receiving receives the 2D design drawing including at least one of a plan view, a sectional view, an elevation view, and a layout drawing for an architecture book or an interior design book of the at least one building.

3. The method of claim 2, wherein the creating of the building model identifies a type and scale of components forming the at least one building based on the 2D design drawing, and places a 3D element model, which is previously stored according to the type of the identified component, according to an identified scale, thereby generating a 3D building model.

4. The method of claim 1, wherein the creating of the virtual reality space creates a virtual solar model in the created virtual reality space, estimates solar azimuth and solar altitude by time based on a latitude and longitude corresponding to an actual location of the 3D building model, and generates real-time sunshine and shadows in the virtual reality space according to the estimated solar azimuth and solar altitude.

5. The method of claim 1, wherein the creating of the virtual reality space receives point cloud data acquired by a lidar at a preset location in real space corresponding to the virtual reality space, and creates an outdoor environment model for the created 3D building model based on the received point cloud data.

6. The method of claim 1, further comprising:
after the creating of the virtual reality space,
providing a service to user equipment by placing an avatar corresponding to a user within the virtual reality space.

7. The method of claim 6, wherein the providing controls action of the avatar in the virtual reality space according to an input signal that is input from the user equipment, and implements contents corresponding to the action of the avatar in the virtual reality space.

8. The method of claim 7, wherein the providing provides a front view based on eyes of the avatar within the virtual reality space, receives the avatar's height information from the user equipment, and adjusts a viewpoint based on the received height information.

9. The method of claim 7, wherein the providing provides a user interface (UI) to change a location or design of the selected component and changes the location or design of the selected component according to an input from the user equipment through the user interface, when the avatar is placed inside the 3D building model and one of the components of the 3D building model is selected from the user equipment.

10. A computer program recorded on a recording medium,
wherein the computer program is coupled to a computing device comprising:
a memory;
a transceiver; and
a processor processing a command loaded in the memory,
whereby the computer program executes:
5 receiving a 2D design drawing for at least one building, by a processor;
creating a 3D building model based on the received 2D design drawing, by the processor; and
creating a virtual reality space by processing the created 3D building model, by the processor.
